(19) United States
(12) Patent Application Publication
(10) Pub. No.: US 2014/0014436 A1
(43) Pub. Date: Jan. 16, 2014

(54) Noise-Reducing Air Inlet Grille for an Appliance

(71) Applicant: B/E AEROSPACE, INC., Wellington, FL (US)

(72) Inventors: William H. Nguyen, Ontario, CA (US); Vandaud M. Imani, Rancho Santa Margarita, CA (US); William Godecker, Irvine, CA (US)

(21) Appl. No.: 13/940,012

(22) Filed: Jul. 11, 2013

Related U.S. Application Data
(60) Provisional application No. 61/670,696, filed on Jul. 12, 2012.

(51) Int. Cl. B64F 1/26

(52) U.S. Cl. CPC B64F 1/26
USPC 181/210

(57) ABSTRACT

An air inlet grille for an appliance onboard an aircraft includes a screen having an inside-facing surface and an outside-facing surface, a plurality of airflow openings formed within the screen between the inside-facing surface and the outside-facing surface, and a plurality of tubes disposed on the inside-facing surface of the screen where openings on one end of the plurality of tubes are aligned with the plurality of airflow openings. A length of the plurality of tubes is at least twice a diameter of the plurality of airflow openings with which the plurality of tubes is aligned.

### CROSS-REFERENCE TO RELATED APPLICATION

This application claims the priority benefit of U.S. Provisional Patent Application No. 61/670,696 entitled “NOISE-REDUCING AIR INLET GRILLE FOR A BEVERAGE CHILLER” and filed on Jul. 12, 2012, which is hereby incorporated herein by reference in its entirety.

### BACKGROUND

1. Field

Embodiments disclosed herein relate to air inlet grilles for appliances, and more specifically to air inlet grilles for appliances onboard an aircraft.

2. Related Art

A conventional air inlet grille for an appliance onboard an aircraft typically has a screen with openings disposed therein, where the openings are flat with an inside-facing surface and an outside-facing surface of the screen. These openings allow air to flow through the screen, where the air flows through the openings in any direction and angle. Eddies are formed as the openings funnel the air into the appliance. The eddies in turn create whistling sounds. In addition, sound waves of airborne noise within the appliance bounce off reflective surfaces of components within the appliance and exit through the grille screen, thus generating unwanted airborne noise outside the appliance. Because products for use in galleys of new aircraft must meet low noise level requirements, conventional air inlet grilles for appliances onboard aircraft may be too noisy to meet the low noise requirements.

### SUMMARY

Various embodiments of an air inlet grille reduce noise that is typically generated by an appliance by reducing or eliminating air current eddies at the grille and some of the airborne noise that exits the grille while still maintaining steady incoming airflow. In various embodiments, an air inlet grille for an appliance onboard an aircraft includes a screen having an inside-facing surface and an outside-facing surface, a plurality of airflow openings formed within the screen between the inside-facing surface and the outside-facing surface, and a plurality of tubes disposed on the inside-facing surface of the screen where openings on one end of the plurality of tubes are aligned with the plurality of airflow openings. The tubes allow air to flow through the grille while reducing or eliminating air current eddies at the grille and some of the airborne noises that exit the grille. The tubes direct the air in a single direction, thus reducing or eliminating the formation of eddies and whistling sounds. In addition, the orientation and length of the tubes may cause the tubes to act as polarizing sound wave barriers. As sound waves bounce off reflective surfaces of the interior of the appliance to exit the grille, sound waves that come into contact with the tubes at an angle may disperse and dissipate. Thus, only sound waves that are substantially aligned with the orientation of the tubes may flow through the tubes to exit the grille. Furthermore, the length of the tubes is configured to reduce a drop in air pressure across the tubes so that incoming airflow through the grille screen is not negatively impacted.

Because products for use in galleys of new aircraft must meet very low noise level requirements, the air inlet grilles disclosed herein may help aircraft galley appliances comply with the low noise requirements. Because the tubes reduce the formation of eddies and whistling sounds and may disperse and dissipate the sound waves coming into contact with the tubes at an angle, the tubes help reduce airborne noise to a level below the noise requirement and below the noise generated by an appliance having a conventional air inlet grille.

In an embodiment, an air inlet grille for an appliance onboard an aircraft includes a screen having an inside-facing surface and an outside-facing surface, a plurality of airflow openings formed within the screen between the inside-facing surface and the outside-facing surface, and a plurality of tubes disposed on the inside-facing surface of the screen where openings on one end of the plurality of tubes are aligned with the plurality of airflow openings. A length of the plurality of tubes is at least twice a diameter of the plurality of airflow openings with which the plurality of tubes is aligned.

The length of the plurality of tubes may be least three times the diameter of the plurality of airflow openings.

The length of the plurality of tubes may be at least four times the diameter of the plurality of airflow openings.

The length of the plurality of tubes may be about 1 inch. The diameter of the plurality of airflow openings may be about 0.25 inch.

The plurality of tubes may be formed of an extruded plastic material.

The plurality of tubes may be formed of a metallic material.

Walls of the plurality of tubes may be attached to one another.

The walls of the plurality of tubes may be spaced apart from one another.

In another embodiment, an appliance onboard an aircraft includes a housing and an air inlet grille. The air inlet grille includes a screen having an inside-facing surface and an outside-facing surface, a plurality of airflow openings formed within the screen between the inside-facing surface and the outside-facing surface, and a plurality of tubes disposed on the inside-facing surface of the screen where openings on one end of the plurality of tubes are aligned with the plurality of airflow openings. A length of the plurality of tubes is at least twice a diameter of the plurality of airflow openings with which the plurality of tubes is aligned.

The appliance may be selected from the group consisting of refrigerator, freezer, beverage chiller, and oven.

In yet another embodiment, an air inlet grille for an appliance onboard an aircraft includes a screen having an inside-facing surface and an outside-facing surface, a plurality of airflow openings formed within the screen between the inside-facing surface and the outside-facing surface, and a plurality of tubes disposed on the inside-facing surface of the screen wherein openings on one end of the plurality of tubes are aligned with the plurality of airflow openings. A length of the plurality of tubes is about four times a diameter of the plurality of airflow openings with which the plurality of tubes is aligned.

While the exemplary embodiments described herein are presented in the context of noise-reducing air inlet grilles for aircraft galley beverage chillers, these embodiments are exemplary only and are not to be considered limiting. The embodiments of the apparatus and configuration are not limited to aircraft galley beverage chillers. For example, embodiments of the apparatus and configuration may be adapted for other appliances onboard an aircraft, such as an air chiller, air conditioner, heater, refrigerator, oven, and other food cooling and warming devices. Various embodiments may be used with appliances in any vehicle, including aircraft, spacecraft, ships, buses, trains, recreational vehicles, trucks, automobiles, and the like that have a low noise requirement. Embodiments of the apparatus may also be used in homes, offices, hotels, factories, warehouses, garages, and other buildings where it may be desirable to use a noise-reducing air inlet grille.

### BRIEF DESCRIPTION OF THE DRAWINGS

The above and other features and advantages of the invention will become more apparent by describing in detail exemplary embodiments thereof with reference to the attached drawings listed below.

FIG. 1 is a perspective view illustrating a conventional air inlet grille for an appliance onboard an aircraft.

FIG. 2 is a perspective view illustrating an air inlet grille for an appliance onboard an aircraft, according to an embodiment.

FIG. 3 is a graph illustrating a comparison of airborne noise using the conventional air inlet grille of FIG. 1 and the air inlet grille of FIG. 2.

FIG. 4 is a perspective view illustrating an aircraft galley beverage chiller having the air inlet grille of FIG. 2, according to an embodiment.

FIG. 5 is a front view of the aircraft galley beverage chiller of FIG. 4 having the air inlet grille of FIG. 2, according to an embodiment.

### DETAILED DESCRIPTION

As described herein, noise-reducing air inlet grilles reduce airborne noise generated by an appliance by reducing an amount of the noise generated by air flowing in the appliance and an amount of noise that escapes through openings of the air inlet grilles. In various embodiments, an air inlet grille for an appliance onboard an aircraft includes a screen having an inside-facing surface and an outside-facing surface, a plurality of airflow openings formed within the screen between the inside-facing surface and the outside-facing surface, and a plurality of tubes disposed on the inside-facing surface of the screen where openings on one end of the plurality of tubes are aligned with the plurality of airflow openings. The plurality of tubes allows air to flow through the grille while reducing or eliminating some of the airborne noise that exits the grille. The tubes direct the air in a single direction, thus reducing or eliminating the formation of eddies and whistling sounds. In addition, the orientation and length of the tubes may cause the tubes to act as polarizing sound wave barriers. As sound waves bounce off reflective surfaces of the interior of the appliance to exit the grille, sound waves that come into contact with the tubes at an angle may disperse and dissipate. Thus, only sound waves that are substantially aligned with the orientation of the tubes may flow through the tubes to exit the grille. Furthermore, the length of the tubes is configured to reduce a drop in air pressure across the tubes so that incoming airflow through the grille screen is not negatively impacted.

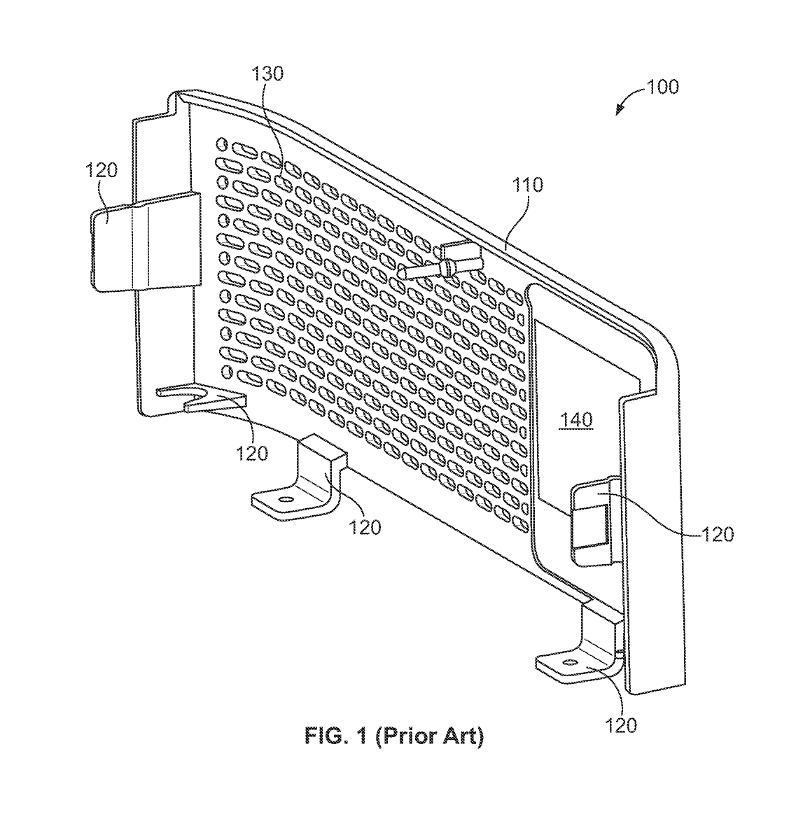

FIG. 1 is a perspective view illustrating a conventional air inlet grille 100 for an appliance onboard an aircraft. As illustrated in FIG. 1, the conventional air inlet grille 100 has a screen 110, mounting elements 120, airflow openings 130 disposed in the screen 110 and that are flat with an inside-facing surface and an outside-facing surface of the screen 110, and a display opening 140 in the screen 110 for a display or control panel. The airflow openings 130 allow air to flow through the screen 110. Both air and airborne noise may enter and exit the airflow openings 130 at any direction and angle. Eddies are formed as the air funnels through the airflow openings 130 in the screen 120. The eddies in turn may generate whistling sounds. In addition, sound waves generated by the appliance and that bounce off reflective surfaces of components within the appliance may be incident upon the screen 110 at various angles and exit the airflow openings 130 regardless of their angles of incidence. Therefore, the conventional air inlet grille 100 allows excessive unwanted airborne noise to emanate from the appliance. Because products for use in galleys of new aircraft must meet low noise level requirements, appliances having the conventional air inlet grille 100 may be too noisy to meet the low noise requirements.

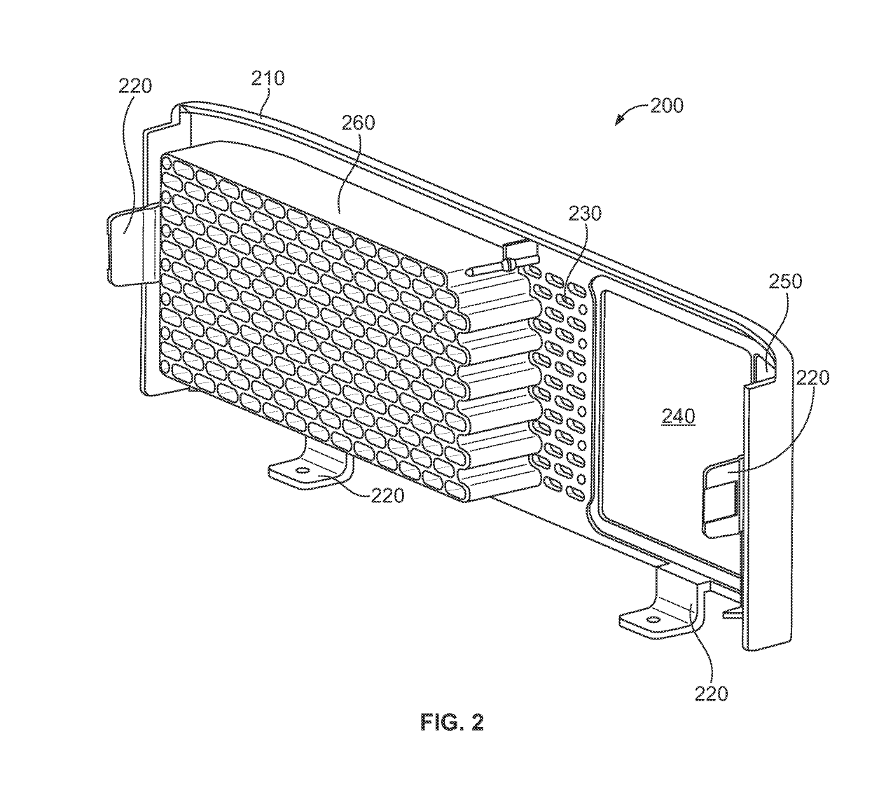

FIG. 2 is a perspective view illustrating a noise-reducing air inlet grille 200 for an appliance onboard an aircraft, according to an embodiment. As illustrated in FIG. 2, the air inlet grille 200 includes a screen 210 having an inside-facing surface and an outside-facing surface (the inside-facing surface is shown in FIG. 2), a plurality of airflow openings 230 formed within the screen 210 between the inside-facing surface and the outside-facing surface, and a plurality of tubes 260 disposed on the inside-facing surface of the screen 210 where openings on one end of the plurality of tubes 260 are substantially aligned with the plurality of airflow openings 230. The air inlet grille 200 may further include mounting elements 220, which allow the air inlet grille 200 to be removably mounted or coupled to an appliance onboard an aircraft.

The tubes 260 allow air to flow through the grille screen 210 while reducing some of the airborne noise that exits the grille 200. The tubes 260 direct the air in a single direction, thus reducing or eliminating the formation of eddies and whistling sounds. In addition, the orientation and length of the tubes 260 may cause the tubes 260 to act as polarizing sound wave barriers. As sound waves bounce off reflective surfaces of components within the appliance to exit the grille 200, sound waves that come into contact with the tubes 260 at an angle may disperse and dissipate. Thus, only sound waves that are aligned with the orientation of the tubes 260 may flow through the tubes 260 and screen 210 to exit the grille 200. Furthermore, the length of the tubes 260 may be configured to reduce a drop in air pressure across the tubes 260 so that incoming airflow through the tubes 260 is not negatively impacted.

In the embodiment shown in FIG. 2, the length of the tubes 260 is about 1 inch, and the diameter of the airflow openings 230 is about 0.25 inch. The screen 210 may be about 0.1 inch thick. In another embodiment, the length of the tubes 260 may be at least twice the diameter of the airflow openings 230 with which the tubes 260 are aligned. In other embodiments, the length of the tubes 260 may be least three times the diameter of the airflow openings 230. In yet other embodiments, the length of the tubes 260 may be at least four times the diameter of the airflow openings 230. Because the tubes 260 reduce or eliminate the formation of eddies and whistling sounds caused by air flowing through the airflow openings 230, longer tubes 260 may reduce more noise generated by the appliance.

Furthermore, as shown in FIG. 2, walls of the tubes 260 are attached to one another. In other embodiments, to reduce weight of the appliance to meet the weight requirement for an aircraft, walls of the tubes 260 may be spaced apart from one another so that less material is used. In various embodiments, the tubes 260 may be formed of an extruded plastic material or a metallic material.

Because appliances for use in galleys of new aircraft must meet very low noise level requirements, the air inlet grille 200 may help appliances onboard an aircraft to comply with the low noise requirements. The tubes 260 of the grille 200 reduce an amount of noise exiting the appliances through the screen 210, and thus help reduce airborne noise to a level below the noise requirement and below the noise generated by appliances that use the conventional air inlet grille 100 of FIG. 1.

The air inlet grille 200 may further include additional airflow openings 230 that are disposed in the screen 210 but not attached to the tubes 260. The additional airflow openings 230 may allow more air to flow through the grille 200 or may allow components of the appliance to be mounted close to the screen 210 and airflow openings 230 without having the tubes 260 therebetween. The air inlet grille 200 may also include a display opening 240 in the screen 210 for a display or control panel that is mounted on the appliance, and button openings 250 in the screen 210 for power, control, or other configuration buttons that are mounted on the appliance.

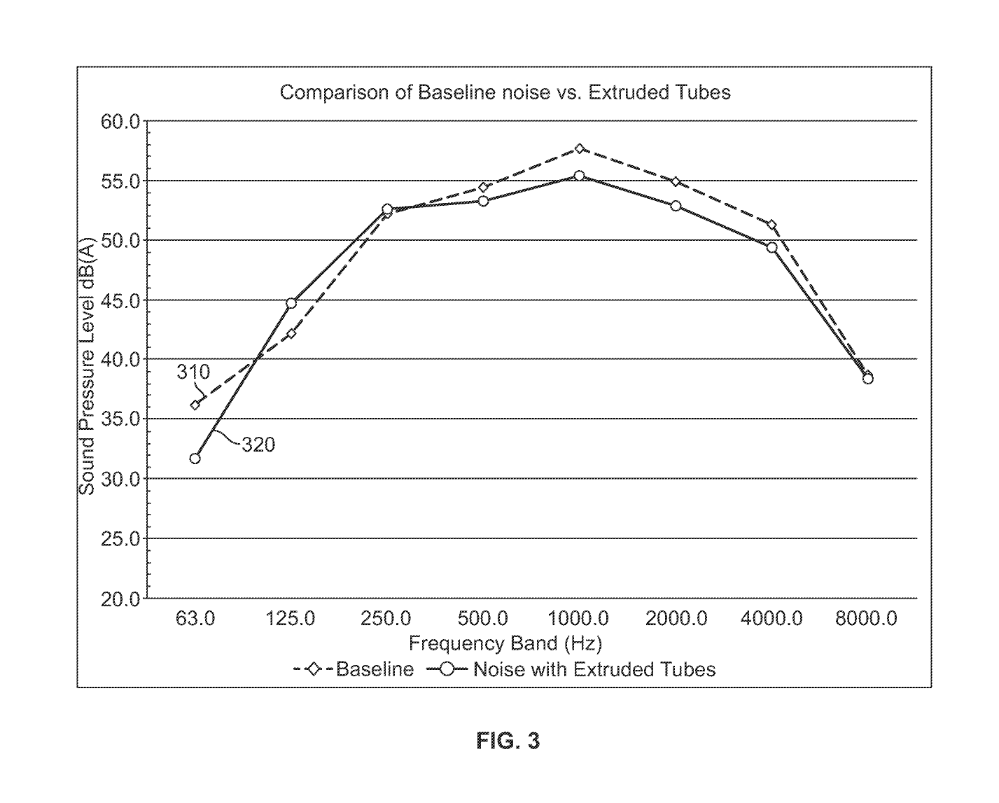

FIG. 3 is a graph illustrating a comparison of airborne noise using the conventional air inlet grille 100 of FIG. 1 and the air inlet grille 200 of FIG. 2. As illustrated in FIG. 3, the horizontal x-axis of the graph represents frequency band in Hertz (Hz), and the vertical y-axis of the graph represents sound pressure level (noise level) in A-weighted decibels (dB(A)). Line 310 illustrates the baseline noise using the conventional air inlet grille 100 of FIG. 1. Line 320 illustrates the noise using the air inlet grille 200 having the plurality of tubes 260, as shown in FIG. 2. As shown in the graph of FIG. 3, at frequencies at and above 500 Hz, the sound pressure level of line 320 is less than the sound pressure level of line 310. In other words, at frequencies at and above 500 Hz, the noise of an appliance using the air inlet grille 200 having the plurality of tubes 260 is less than the noise of the appliance using the conventional air inlet grille 100.

Table 1 below lists the sound pressure levels of line 310 and line 320 at various frequencies, as illustrated in FIG. 3. As shown in Table 1, at 500 Hz, the air inlet grille 200 reduces the sound pressure level, or noise level, of an appliance using the conventional air inlet grille 100 by about 1 dB(A). At 1000 Hz, the air inlet grille 200 reduces noise level by about 3 dB(A). At 2000 Hz and 4000 Hz, the air inlet grille 200 reduces noise level by about 2 dB(A).

TABLE 1

| | Sound Pressure Level | | |
|---|---|---|---|
| | Line 310 | Line 320 | Sound Pressure |
| | (conventional air | (noise-reducing air | (Noise) Level |
| Frequency | inlet grille 100) | inlet grille 200) | Reduction |
| 500 Hz | 54 dB(A) | 53 dB(A) | 1 dB(A) |
| 1000 Hz | 58 dB(A) | 55 dB(A) | 3 dB(A) |
| 2000 Hz | 55 dB(A) | 53 dB(A) | 2 dB(A) |
| 4000 Hz | 51 dB(A) | 49 dB(A) | 2 dB(A) |

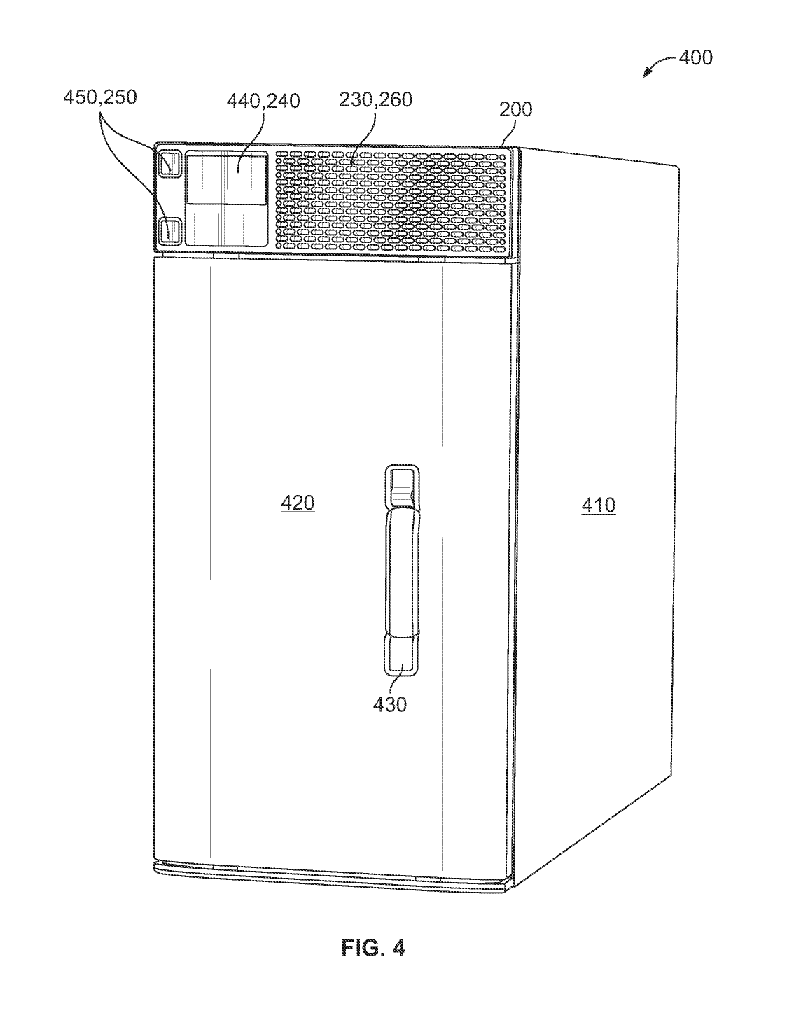

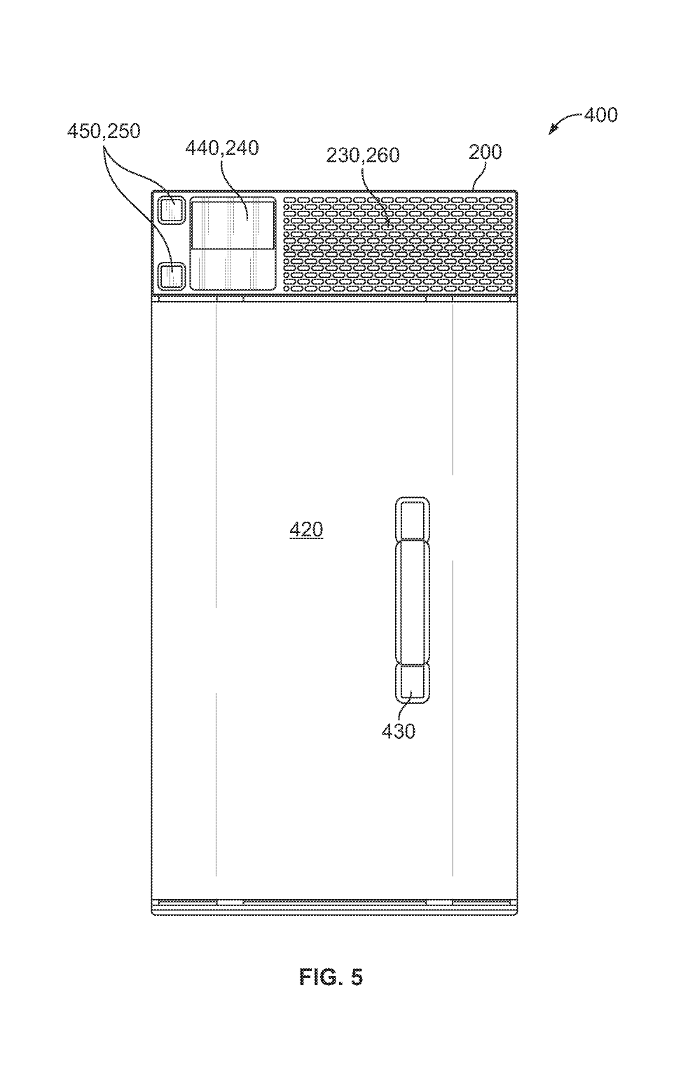

FIG. 4 is a perspective view illustrating an aircraft galley beverage chiller 400 having the air inlet grille 200 of FIG. 2, according to an embodiment. FIG. 5 is a front view of the aircraft galley beverage chiller 400 of FIG. 4 having the air inlet grille 200 of FIG. 2, according to an embodiment. Although the beverage chiller 400 is shown in FIGS. 4 and 5, the air inlet grille 200 may be used on any appliance onboard an aircraft, for example, refrigerators, freezers, ovens, and other food warming or cooling devices.

As illustrated in FIGS. 4 and 5, the aircraft galley beverage chiller 400 includes a housing 410 and the air inlet grille 200 removably mounted to the housing 410. The air inlet grille 200 includes a screen 210 (FIG. 2) having an inside-facing surface and an outside-facing surface, a plurality of airflow openings 230 formed within the screen 210 between the inside-facing surface and the outside-facing surface, and a plurality of tubes 260 disposed on the inside-facing surface of the screen 210 where openings on one end of the plurality of tubes 260 are aligned with the plurality of airflow openings 230. A length of the plurality of tubes 260 is at least twice a diameter of the plurality of airflow openings 230 with which the plurality of tubes 260 is aligned. The aircraft galley beverage chiller 400 further includes a door 420 attached to the housing 410 and a handle 430 disposed on an outer surface of the door 420.

According to FIGS. 4 and 5, the mounting elements 220 (FIG. 2) of the grille 200 are removably coupled to the housing 410 of the beverage chiller 400 so that the grille 200 is removably mounted to the beverage chiller 400. The airflow openings 230 formed within the screen 210 allow room temperature air to flow through the tubes 260 into the housing 410, for example, by an airflow created by a fan within the housing 410. The tubes 260 reduce some of the airborne noise generated by the beverage chiller 400 so that the airborne noise exiting the beverage chiller 400 is reduced. The tubes 260 direct the air in a single direction, thus reducing or eliminating the formation of eddies and whistling sounds. In addition, the orientation and length of the tubes 260 may cause the tubes 260 to act as polarizing sound wave barriers. As sound waves bounce off reflective surfaces of components within the beverage chiller 400 to exit the grille 200, sound waves that come into contact with the tubes 260 at an angle may disperse and dissipate. Thus, only sound waves that are substantially aligned with the orientation of the tubes 260 may flow through the tubes 260 and screen 210 to exit the grille 200. Furthermore, the length of the tubes 260 may be configured to reduce a drop in air pressure across the tubes 260 so that incoming airflow through the tubes 260 is not negatively impacted.

Also shown in FIGS. 4 and 5, the air inlet grille 200 may include a display opening 240 in the screen 210 for a display panel 440 that is mounted on the housing 410. The grille 200 may further include button openings 250 in the screen 210 for control buttons 450 that are mounted on the housing 410 of the beverage chiller 400.

While the exemplary embodiments described herein are presented in the context of noise-reducing air inlet grilles for aircraft galley beverage chillers, these embodiments are exemplary only and are not to be considered limiting. The embodiments of the apparatus and configuration are not limited to aircraft galley beverage chillers. For example, embodiments of the apparatus and configuration may be adapted for other appliances onboard an aircraft, for example, an air chiller, air conditioner, heater, refrigerator, oven, and other food cooling and warming devices. Various embodiments may be used with appliances in any vehicle, including aircraft, spacecraft, ships, buses, trains, recreational vehicles, trucks, automobiles, and the like that have a low noise requirement. Embodiments of the apparatus may also be used in homes, offices, hotels, factories, warehouses, garages, and other buildings where it may be desirable to use a noise-reducing air inlet grille.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. An air inlet grille for an appliance onboard an aircraft comprising:
a screen having an inside-facing surface and an outside-facing surface;
a plurality of airflow openings formed within the screen between the inside-facing surface and the outside-facing surface; and
a plurality of tubes disposed on the inside-facing surface of the screen wherein openings on one end of the plurality of tubes are aligned with the plurality of airflow openings,
wherein a length of the plurality of tubes is at least twice a diameter of the plurality of airflow openings with which the plurality of tubes is aligned.

2. The air inlet grille of claim 1, wherein the length of the plurality of tubes is at least three times the diameter of the plurality of airflow openings.

3. The air inlet grille of claim 1, wherein the length of the plurality of tubes is at least four times the diameter of the plurality of airflow openings.

4. The air inlet grille of claim 1, wherein the length of the plurality of tubes is about 1 inch.

5. The air inlet grille of claim 1, wherein the diameter of the plurality of airflow openings is about 0.25 inch.

6. The air inlet grille of claim 1, wherein the plurality of tubes is formed of an extruded plastic material.

7. The air inlet grille of claim 1, wherein the plurality of tubes is formed of a metallic material.

8. The air inlet grille of claim 1, wherein walls of the plurality of tubes are attached to one another.

9. The air inlet grille of claim 1, wherein walls of the plurality of tubes are spaced apart from one another.

10. An appliance onboard an aircraft comprising:
a housing; and
an air inlet grille comprising a screen having an inside-facing surface and an outside-facing surface, a plurality of airflow openings formed within the screen between the inside-facing surface and the outside-facing surface, and a plurality of tubes disposed on the inside-facing surface of the screen wherein openings on one end of the plurality of tubes are aligned with the plurality of airflow openings,
wherein a length of the plurality of tubes is at least twice a diameter of the plurality of airflow openings with which the plurality of tubes is aligned.

11. The appliance of claim 10, wherein the length of the plurality of tubes is at least three times the diameter of the plurality of airflow openings.

12. The appliance of claim 10, wherein the length of the plurality of tubes is at least four times the diameter of the plurality of airflow openings.

13. The appliance of claim 10, wherein the length of the plurality of tubes is about 1 inch.

14. The appliance of claim 10, wherein the diameter of the plurality of airflow openings is about 0.25 inch.

15. The appliance of claim 10, wherein the plurality of tubes is formed of an extruded plastic material.

16. The appliance of claim 10, wherein the plurality of tubes is formed of a metallic material.

17. The appliance of claim 10, wherein walls of the plurality of tubes are attached to one another.

18. The appliance of claim 10, wherein walls of the plurality of tubes are spaced apart from one another.

19. The appliance of claim 10, wherein the appliance is selected from the group consisting of refrigerator, freezer, beverage chiller, and oven.

20. An air inlet grille for an appliance onboard an aircraft comprising:
a screen having an inside-facing surface and an outside-facing surface;
a plurality of airflow openings formed within the screen between the inside-facing surface and the outside-facing surface; and
a plurality of tubes disposed on the inside-facing surface of the screen wherein openings on one end of the plurality of tubes are aligned with the plurality of airflow openings,
wherein a length of the plurality of tubes is about four times a diameter of the plurality of airflow openings with which the plurality of tubes is aligned.
